(19) United States
(12) Patent Application Publication
(10) Pub. No.: US 2010/0132220 A1
(43) Pub. Date: Jun. 3, 2010

(54) METHOD AND APPARATUS FOR DRYING ARTICLES

(75) Inventors: Lay-Swee Lim, Burnaby (CA); Jiri Kutak-Petrik, Port Coquitlam (CA); Zhong Xu Su, Burnaby (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Northwestern Systems Corporation, Delta (CA)

(21) Appl. No.: 12/325,904

(22) Filed: Dec. 1, 2008

(51) Int. Cl. F26B 3/00; B65G 47/40; B65G 47/00; F26B 3/02

(52) U.S. Cl. 34/500; 198/529; 198/617; 34/326

(57) ABSTRACT

A tunnel dryer apparatus and method is disclosed. In one aspect, the apparatus includes a drying chamber having an infeed end for receiving articles to be dried, and a conveyor for conveying the articles through the drying chamber along a drying path to a discharge end of the drying chamber. The drying path includes at least one portion having a gradient for causing the articles to be tilted to distribute accumulated liquid on surfaces of the articles thereby facilitating drying of the article. In another aspect the apparatus includes a nozzle, operably configured to direct a pulsating jet of air toward passing articles thereby causing accumulated liquid on surfaces of the articles to be dispersed to facilitate drying of the article.

### BACKGROUND OF THE INVENTION

1. Field of Invention This invention relates generally to drying articles and more particularly to drying articles in a tunnel dryer.

2. Description of Related Art

Many scientific laboratories or life science facilities run scientific experiments on a continuous basis and may utilize re-usable articles that require thorough washing prior to re-use. One example of such articles requiring regular washing are the cages used to house rodents or other small animals for use in live-animal experimentation. Simple rodent cages are fabricated as shoebox sized polycarbonate bins that are received in a rack system when housing the live-animal. A bedding material is used to at least partially cover a floor of the cage when holding the rodent. The rodents may be periodically relocated to a clean cage with new bedding, at which time the soiled cage would be washed and later re-used.

Laboratories conducting extensive live-animal experiments may make use of a tunnel washer for washing cages. Conventional tunnel washers have a conveyor belt running between a load end and an unload end of the washer. The cages (or other articles being washed) are stacked side by side on a loading portion of the conveyor belt and the cages are conveyed through a pre-wash section, a washing section, a rinse section, and through a drying section, before discharging the cages at the unload end. The Better Built® T2000 series tunnel washers produced by Northwestern Systems Corp. of British Columbia, Canada may be configured to have a 36 inch long load section, a 48 inch long pre-wash section, a 48 inch long wash section, a 60 inch long rinse section, a 96 inch long dryer section and a 48 inch long unload section for an overall length of about 28 feet, for example. Conveyor widths may range from 24 inches to 48 inches. In other embodiments the length of the various sections may be varied to suit specific washing and/or drying requirements.

To maintain a reasonable throughput of cages through the tunnel washer, the conveyor may be configured to run at a speed of between 2 and 6 feet per minute. For example a typical 96 inch dryer may have a speed of 3-4 feet per minute which corresponds to a transit time through the dryer section of about 140 seconds, and accordingly it is not unusual for at least some of the cages to not be completely dried when discharged from the dryer section.

### SUMMARY OF THE INVENTION

In accordance with one aspect of the invention there is provided a tunnel dryer apparatus. The apparatus includes a drying chamber having an infeed end for receiving articles to be dried, and a conveyor for conveying the articles through the drying chamber along a drying path to a discharge end of the drying chamber. The drying path includes at least one portion having a gradient for causing the articles to be tilted to distribute accumulated liquid on surfaces of the articles thereby facilitating drying of the article.

The at least one portion of the drying path having the gradient may include a descending gradient portion of the drying path.

The descending gradient portion of the drying path may include a downwardly inclined ramp having a receiving end for receiving the articles, the downwardly inclined ramp being operable to cause the articles to slide under forces of gravity along the ramp toward a discharge end of the ramp.

The downwardly inclined ramp may be operably configured to cause the articles to be decelerated proximate the discharge end of the ramp to dislodge residual accumulated liquid on the surfaces of the articles.

The conveyor may include a first conveyor portion extending between the infeed end of the drying chamber and the receiving end of the ramp.

The conveyor may include a second conveyor portion extending between the discharge end of the ramp and the discharge end of the drying chamber, the second conveyor portion being operable to receive the articles from the discharge end of the ramp.

The second conveyor portion may have an ascending gradient for causing the articles to be tilted in an opposite direction with respect to the tilting direction provided by the ramp.

The apparatus may include a generally horizontal conveyor portion following the ascending gradient second conveyor portion.

The first conveyor portion and the second conveyor portion may include a continuous conveyor belt extending between the infeed end and the discharge end of the drying chamber and the ramp may be disposed above the continuous conveyor and extends between the first and the second conveyor portions.

The apparatus may include a first roller located proximate the receiving end of the ramp for redirecting the continuous conveyor belt behind the ramp to form the first conveyor portion extending between the infeed end of the tunnel dryer and the first roller.

The first roller may be supported at distally located ends of the first roller by a heat resistant bushing.

The heat resistant bushing may include Rulon J material.

The apparatus may include a second roller located to redirect the continuous conveyor belt to pass under the discharge end of the ramp to form the second conveyor portion extending between the discharge end of the ramp and the discharge end of the drying chamber.

The infeed end of the drying chamber may be in communication with a discharge end of a tunnel washer for receiving articles to be dried.

The articles to be dried may include laboratory containers for holding live animals for scientific experimentation and the discharge end of the drying chamber may be in communication with a bedding dispenser for dispensing bedding material into the laboratory containers.

The apparatus may include a nozzle located along the drying path, the nozzle being operably configured to cause a pulsating jet of air to impinge on passing articles thereby causing accumulated liquid on surfaces of the articles to be dispersed to facilitate drying of the article.

The drying chamber may include a plurality of channels for receiving heated air for drying the articles, at least one of the channels being oriented to direct heated air toward articles passing the at least one portion having the gradient.

In accordance with another aspect of the invention there is provided a method for drying articles in a tunnel dryer. The method involves receiving articles to be dried at an infeed end of a drying chamber of the tunnel dryer, and conveying the articles through the drying chamber along a drying path to a discharge end of the drying chamber. The drying path includes at least one portion having a gradient for causing the articles to be tilted to distribute accumulated liquid on surfaces of the articles thereby facilitating drying of the article.

Conveying the articles may involve causing the articles to be conveyed along a descending gradient portion of the drying path.

Causing the articles to be conveyed along the descending gradient portion of the drying path may involve causing the articles to be received at a receiving end of a downwardly inclined ramp and causing the articles to slide under forces of gravity along the ramp toward a discharge end of the ramp.

The method may involve causing the articles to be decelerated proximate the discharge end of the ramp to dislodge residual accumulated liquid on the surfaces of the articles.

Receiving the articles at the receiving end of the ramp may involve receiving articles discharged from a first conveyor portion extending between the infeed end of the drying chamber and the receiving end of the ramp.

The method may involve receiving the articles from the discharge end of the ramp at a second conveyor portion extending between the discharge end of the ramp and the discharge end of the drying chamber.

Receiving the articles from the discharge end of the ramp may involve receiving the articles at a second conveyor portion having an ascending gradient for causing the articles to be tilted in an opposite direction with respect to the tilting direction provided by the ramp.

Conveying the articles to a discharge end of the drying chamber may involve conveying articles along a generally horizontal conveyor portion following the ascending gradient second conveyor portion.

The first conveyor portion and the second conveyor portion may include a continuous conveyor belt extending between the infeed end and the discharge end of the drying chamber and receiving the articles at the receiving end of the ramp may involve receiving the articles at a receiving end of a ramp disposed above the continuous conveyor, the ramp extending between the first and the second conveyor portions.

Receiving the articles discharged from the first conveyor portion may involve receiving articles from a first conveyor portion extending between the infeed end of the drying chamber and a first roller, the first roller being operable to redirect the conveyor belt behind the ramp.

The first roller may be supported at distally located ends of the first roller by a heat resistant bushing.

The heat resistant bushing may comprise Rulon J material.

Receiving the articles from the discharge end of the ramp at the second conveyor portion may involve receiving articles at a second portion of the continuous conveyor belt, the continuous conveyor belt being redirected around a second roller located to cause the continuous conveyor belt to pass under the discharge end of the ramp to form the second conveyor portion extending between the discharge end of the ramp and the discharge end of the drying chamber.

Receiving articles to be dried may involve receiving the articles from a discharge end of a tunnel washer.

The articles to be dried may include laboratory containers for holding live animals for scientific experimentation and conveying the articles to the discharge end of the drying chamber may involve discharging the articles into a bedding dispenser for dispensing bedding material into the laboratory containers.

The method may involve to causing a pulsating jet of air to impinge on passing articles thereby causing accumulated liquid on surfaces of the articles to be dispersed to facilitate drying of the article.

The drying chamber may include a plurality of channels for receiving heated air for drying the articles and the method may further involve causing at least a portion of the heated air to be directed toward articles passing the at least one portion having the gradient.

In accordance with another aspect of the invention there is provided a tunnel dryer apparatus. The apparatus includes provisions for receiving articles to be dried at an infeed end of a drying chamber of the tunnel dryer, and provisions for conveying the articles through the drying chamber along a drying path to a discharge end of the drying chamber. The drying path includes at least one portion having a gradient for causing the articles to be tilted to distribute accumulated liquid on surfaces of the articles thereby facilitating drying of the article.

The provisions for conveying the articles may include provisions for causing the articles to be conveyed along a descending gradient portion of the drying path.

The apparatus may include provisions for causing a pulsating jet of air to impinge on passing articles thereby causing accumulated liquid on surfaces of the articles to be dispersed to facilitate drying of the article.

The drying chamber may include a provisions for receiving heated air for drying the articles and may further include provisions for causing at least a portion of the heated air to be directed toward articles passing the at least one portion having the gradient.

In accordance with another aspect of the invention there is provided a tunnel dryer apparatus for drying articles received at an infeed end of a drying chamber. The apparatus includes a conveyor for conveying the articles through the drying chamber along a drying path. The apparatus also includes a nozzle, operably configured to direct a pulsating jet of air toward passing articles thereby causing accumulated liquid on surfaces of the articles to be dispersed to facilitate drying of the article.

The nozzle may include a narrow conduit in communication with a source of pressurized fluid, the narrow conduit having an opening for producing a jet of air, at least one orifice located proximate the opening, the orifice being in communication with an environment surrounding the nozzle such that a pressure drop due to air flow through the narrow conduit causes air from the surrounding environment to be drawn in through the at least one orifice to form the pulsating jet of air.

The apparatus may include a valve operably configured to be selectively actuated to couple a pressurized air source to the nozzle.

The valve may include a solenoid valve operably configured to be selectively actuated in response to receiving an actuation signal.

The actuation signal may include a periodic actuation signal that alternates between an inactive state and an active state, the active state being operable to actuate the solenoid valve to open, and the actuation signal may have a duty cycle of less than two seconds.

The periodic actuation signal may include an active state of about 1.2 seconds and an in-active state of about 0.6 seconds.

The apparatus may include a controller operably configured to generate the actuation signal.

The controller may include a processor circuit operably configured to generate the actuation signal.

The nozzle may include a plurality of spaced apart nozzles, each being located to cause a pulsating jet of air to impinge on a respective one of the adjacent spaced apart articles.

The apparatus may include a common air supply conduit in communication with each of the plurality of spaced apart nozzles, the conduit being in communication with a source of pressurized air for supplying pressurized air to the plurality of spaced apart nozzles.

The drying path may include a first portion extending between the infeed end and a discharge end of the drying chamber and a second portion extending past the discharge end of the drying chamber, and the nozzle may be located along the second portion of the drying path.

The conveyor may include a conveyor belt extending along the drying path, the conveyor belt having a plurality of openings to permit passage of air through the conveyor belt, and the nozzle may be oriented to cause a pulsating jet of air to be directed through one of the plurality of openings.

The nozzle may be oriented to produce an upwardly directed pulsating jet of air.

The nozzle may be oriented to produce a jet of air having an airflow component in a direction of motion of the passing articles.

The nozzle may be oriented to produce a downwardly directed pulsating jet of air.

In accordance with another aspect of the invention there is provided a method for drying articles in a tunnel dryer. The method involves receiving articles to be dried at an infeed end of a drying chamber of the tunnel dryer, and conveying the articles through the drying chamber along a drying path. The method also involves causing a pulsating jet of air to impinge on passing articles thereby causing accumulated liquid on surfaces of the articles to be dispersed to facilitate drying of the article.

Causing the pulsating jet of air to impinge on passing articles may involve selectively supplying pressurized air to a nozzle to generate the pulsating jet of air.

Selectively supplying pressurized air to the nozzle may involve selectively supplying pressurized air to a nozzle having a narrow conduit in communication with a source of pressurized fluid, the narrow conduit having an opening for producing a jet of air, at least one orifice located proximate the opening, the orifice being in communication with an environment surrounding the nozzle such that a pressure drop due to air flow through the narrow conduit causes air from the surrounding environment to be drawn in through the at least one orifice to form the pulsating jet of air.

Selectively supplying pressurized air to the nozzle may involve causing a valve to be selectively actuated to couple a pressurized air source to the nozzle.

Causing the valve to be selectively actuated may involve causing a solenoid valve to be selectively actuated in response to receiving an actuation signal.

Receiving the actuation signal may involve receiving a periodic actuation signal that alternates between an inactive state and an active state, the active state being operable to actuate the solenoid valve to open, and the actuation signal has a duty cycle of less than two seconds.

Receiving the periodic actuation signal may involve receiving a periodic actuation signal having an active state of about 1.2 seconds and an in-active state of about 0.6 seconds.

The method may involve generating the actuation signal.

Generating the actuation signal may involve operably configuring a processor circuit to generate the actuation signal.

Conveying the articles may involve conveying a plurality of adjacent spaced apart articles along the drying path and selectively supplying pressurized air to the nozzle may involve selectively supplying pressurized air to a plurality of spaced apart nozzles, each being located to cause a pulsating jet of air to impinge on a respective one of the adjacent spaced apart articles.

Selectively supplying pressurized air to the plurality of spaced apart nozzles may involve selectively supplying pressurized air to a common air supply conduit in communication with each of the plurality of spaced apart nozzles.

Conveying the articles along the drying path may involve conveying the articles along a drying path having a first portion extending between the infeed end and a discharge end of the drying chamber and a second portion extending past the discharge end of the drying chamber, and causing the pulsating jet of air to impinge on passing articles may involve causing the pulsating jet of air to impinge on passing articles at a location along the second portion of the drying path.

Conveying the articles may involve conveying the articles along a conveyor belt extending along the drying path, the conveyor belt having a plurality of openings to permit passage of air through the conveyor belt, and causing the pulsating jet of air to impinge on passing articles may involve causing a pulsating jet of air to be directed through one of the plurality of openings.

Causing the pulsating jet of air to impinge on passing articles may involve causing an upwardly oriented jet of air to impinge on passing articles.

Causing the upwardly oriented jet of air to impinge on passing articles may involve generating a jet of air having an airflow component in a direction of motion of the passing articles.

Causing the pulsating jet of air to impinge on passing articles may involve causing a downwardly oriented jet of air to impinge on passing articles.

In accordance with another aspect of the invention there is provided a tunnel dryer apparatus for drying articles. The apparatus includes provisions for receiving articles to be dried at an infeed end of a drying chamber of the tunnel dryer, and provisions for conveying the articles through the drying chamber along a drying path. The apparatus also includes provisions for causing a pulsating jet of air to impinge on passing articles thereby causing accumulated liquid on surfaces of the articles to be dispersed to facilitate drying of the article.

The provisions for causing the pulsating jet of air to impinge on passing articles may include provisions for selectively supplying pressurized air to a nozzle to generate the pulsating jet of air.

The provisions for selectively supplying pressurized air to the nozzle may include provisions for causing a valve to be selectively actuated to couple a pressurized air source to the nozzle.

The apparatus may include provisions for generating the actuation signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a side view of a tunnel washer;

FIG. 2 is a perspective view of a tunnel dryer apparatus in accordance with an embodiment of the invention;

FIG. 3 is a cross sectional view of the tunnel dryer apparatus shown in FIG. 2 taken along the lines 3-3;

FIG. 4 is a perspective view of a conveyor support shown in the tunnel dryer of FIG. 2;

FIG. 5 is a portion a conveyor belt of the tunnel washer shown in FIG. 1;

FIG. 6 is a side view of the conveyor belt shown in FIG. 5;

FIG. 7 is a block diagram of an air supply system used in the tunnel dryer shown in FIG. 2;

FIG. 8 is a graphical depiction of an actuation signal waveform for actuating a solenoid valve shown in FIG. 7;

FIG. 9 is a front view of a nozzle used in the tunnel dryer shown in FIG. 2; and

FIG. 10 is a cross-sectional view of the nozzle taken along the line 9-9 shown in FIG. 9.

### DETAILED DESCRIPTION

Referring to FIG. 1, an exemplary tunnel washer is shown generally at 100. The tunnel washer 100 includes a load section 102 and a wash section 104. The wash section 104 includes pre-wash, wash, and rinse stages (not shown). The tunnel washer 100 also includes a tunnel dryer 106, and an unload section 108. A conveyor belt 110 for conveys articles 112 from the load section 102 through the wash section 104. After passing through the wash section 104, the articles 112 will generally have accumulated washing liquid (i.e. predominantly water) on surfaces of the articles. The conveyor belt 110 further conveys the articles 112 through the tunnel dryer 106, to the unload section 108. The tunnel washer 100 also includes at least one driven roller, such as the roller 114, which is coupled to a motor (not shown) for receiving a drive torque for advancing the conveyor belt. The tunnel washer 100 further includes a plurality of idler rollers (such as the rollers 116), which support and guide the conveyor belt 110 through the tunnel washer 100.

The unload section 108 facilitates manual unloading of washed and dried articles. Alternatively the unload section 108 may be in communication with a processing apparatus (not shown) for further processing the articles. For example, when the articles being washed in the tunnel washer 100 are cages for holding a live-animal, such further processing may involve automatically dispensing bedding into the cages. In other embodiments, a further roller section (not shown) having a plurality of in-line rollers may be placed to receive the articles discharged from the unload section 108.

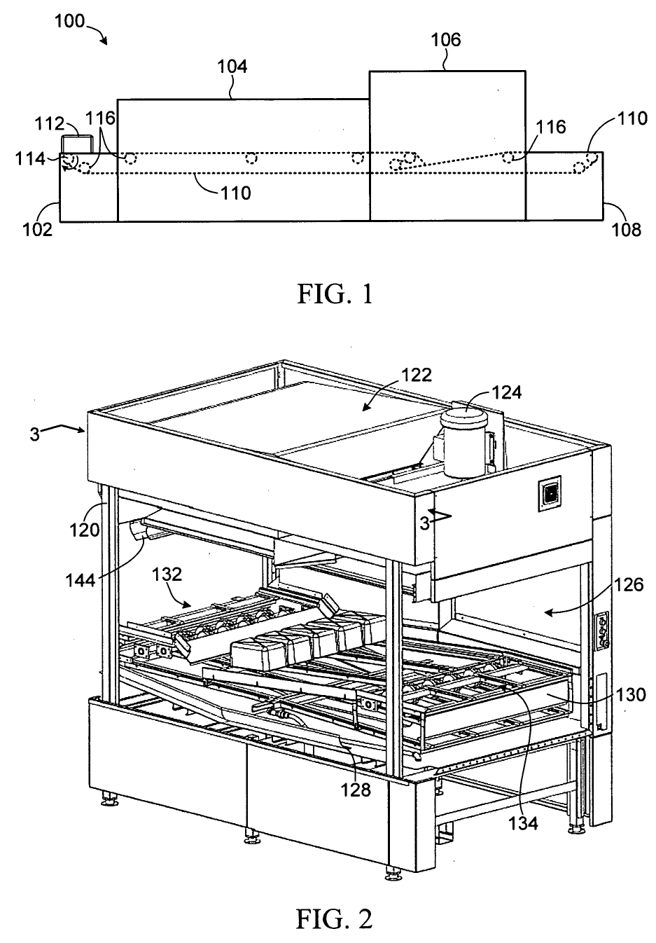

The tunnel dryer apparatus 106 is shown in greater detail in FIG. 2. Referring to FIG. 2, the tunnel dryer 106 includes a frame 120, which supports an air plenum 122. The plenum 122 (shown with an upper covering removed) houses an air supply unit 124.

The tunnel dryer 106 also includes a drying chamber 126. The drying chamber 126 is shown with a side panel removed to show components of the tunnel dryer 106. The drying chamber 126 has an infeed end 132 for receiving wet articles from the wash section 104 and a discharge end 134 for discharging dry articles. The air in the drying chamber 126 is heated to cause the articles 112 passing through the drying chamber to be subjected to elevated temperature to facilitate drying of the articles.

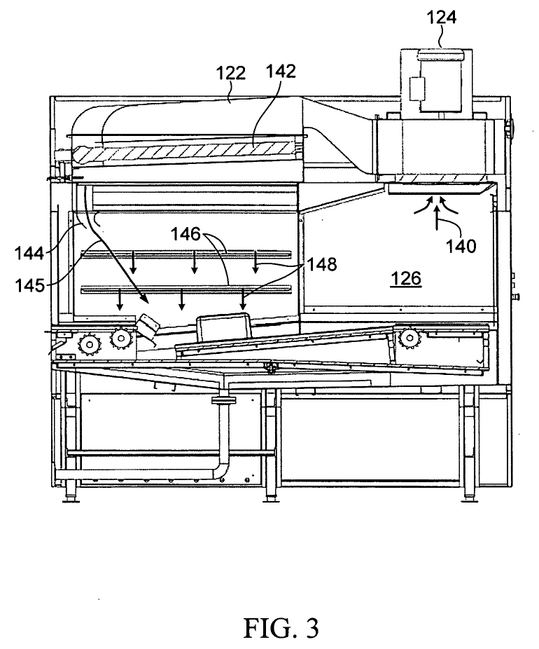

The plenum 122 and air supply unit 124 are shown in cross sectional view in FIG. 3. Referring to FIG. 3, the air supply unit 124 draws in air from the drying chamber 126 as shown by the arrows 140. The air flows though the plenum 122 over a heater element 142 for heating the air. The heated air is then directed through a plurality of channels back to the drying chamber 126. In the embodiment shown in FIG. 3, a first channel 144 is oriented to direct a curtain of air extending across the width of the drying chamber toward the articles 112 from above (as indicated by in the arrow 145). The plenum 122 also extends down sidewalls of the tunnel drier 106 and additional channels 146 are located on the sidewalls and provide downwardly directed airflow as shown by the arrows 148. Referring back to FIG. 2, the downwardly directed airflow is also deflected inwardly in the drying chamber by a scoop shaped baffle 128. The heated air causes a general temperature elevation in the drying chamber 126 and also causes the articles 112 to be heated, such that a surface temperature of the articles becomes elevated. Additionally air currents due to the flow of air toward the articles (such as the flow of air from the channel 136) cause evaporative drying of the articles 112.

The tunnel dryer 106 further includes a conveyor support 130 for supporting the conveyor belt 110 (shown in FIG. 1). The conveyor support 130 extends between the infeed end 132 and the discharge end 134 of the drying chamber 126.

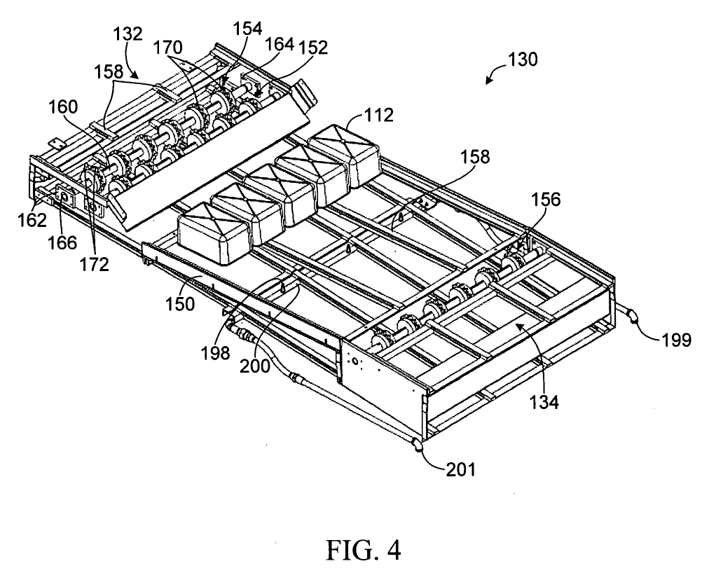

The conveyor support 130 is shown in greater detail in FIG. 4. Referring to FIG. 4, the conveyor support 130 includes a frame 150 having a first roller 152, a second roller 154, and a third roller 156 for supporting the conveyor belt (not shown in FIG. 4). The frame 150 also includes a plurality of low friction guide surfaces 158 for supporting the conveyor belt. In one embodiment the guide surfaces 158 are fabricated from Teflon to withstand elevated drying temperatures in the drying chamber 126. The conveyor support 130 generally supports and guides the conveyor belt between the infeed end 132 and the discharge end 134 of the drying chamber 126 and defines a drying path along which the articles 112 are conveyed through the drying chamber 126.

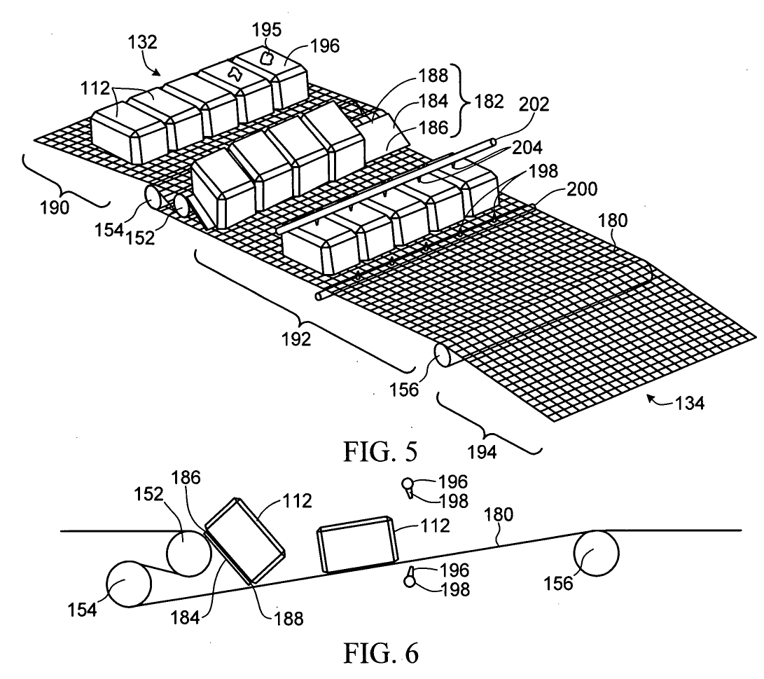

Referring to FIG. 5, a portion the conveyor belt 110 is shown generally at 180. In this embodiment the conveyor belt 180 is part of the continuous conveyor belt 110 shown in FIG. 1, but in other embodiments the tunnel dryer 106 may configured separately from the tunnel washer 100 and the conveyor belt 180 may be localized within the tunnel dryer 106. In this embodiment the conveyor belt 180 is an open mesh stainless steel wire conveyor, which permits air to flow freely through the mesh openings.

The drying path defined by the conveyor belt 180 includes at least one portion 182 having a gradient for causing the articles 112 to be tilted to distribute accumulated liquid on surfaces of the articles thereby facilitating drying of the article. In general, the articles 112 are oriented such that a containing portion of the article 112 is oriented downwardly to allow the articles to drain after washing.

In the embodiment shown, a descending gradient is provided by a downwardly inclined ramp 184. The ramp 184 has a receiving end 186 for receiving the articles 112 from a first portion 190 of the conveyor belt 180. Articles 112 received at the receiving end 186 of the ramp 184 slide under forces of gravity along the ramp toward a discharge end 188 of the ramp. The ramp 184 divides the conveyor belt 180 into the first conveyor portion 190 extending from the infeed end 132 to the receiving end 186 of the ramp, and a second conveyor portion 192 extending between the discharge end 188 of the ramp and the discharge end 134 of the drying chamber 126.

The inventors have observed that liquid tends to accumulate in pools 195 on an upper surface 196 of the articles 112, when the articles are being conveyed in a generally horizontal orientation (for example when traveling along the first portion 190 of the conveyor belt 180). Articles such as polycarbonate cages may also have ridges or surfaces that further cause liquid to be retained on the upper surface 196. Furthermore liquid may also cling to surfaces of the article 112, particularly to horizontal surfaces inside the containing portion of the article. Due to the short transit time through the drying chamber 126, liquid that accumulates as described above may not evaporate before the article is discharged, thereby leaving residual droplets or moisture on articles leaving the discharge end 134 of the drying chamber 126.

Advantageously, the ramp 184 causes the articles 112 to be tilted to cause pooled liquid and liquid droplets to be distributed through forces of gravity to spread out the accumulated liquid over a larger surface area, thereby facilitating evaporative drying of the articles 112. Furthermore, referring back to FIG. 3, are is directed by the channel 144 toward articles 112 in the vicinity of the gradient portion 182, to further facilitate drying of the articles in this region.

The ramp 184 may be fabricated from a material having a smooth surface finish for reducing a coefficient of friction between the articles 112 and the ramp. Forces of gravity acting on the articles 112 thus cause the articles to accelerate along the ramp 184. When respective front edges of the articles engage the second conveyor portion 192 proximate the discharge end 188 of the ramp 184, the articles 112 will be rapidly decelerated causing some residual accumulated liquid on the surfaces of the articles 112 to be dislodged or distributed to further facilitate drying of the articles.

The conveyor belt 180 is shown in cross section in FIG. 6. Referring to FIG. 6, in the embodiment shown, the second conveyor portion 192 has an ascending gradient, which causes articles 112 received from the discharge end 188 of the ramp 184 to undergo a change in orientation. The ramp 184 causes the articles 112 to be initially disposed at a first angle α₁ with respect to a horizontal reference line, and while the articles being conveyed along the second conveyor portion 192 are disposed at a second angle α₂ with respect to the horizontal. Accordingly the ramp 184 and the ascending gradient second conveyor portion 192 causes the articles to be tilted through an angle α₂-α₁. Advantageously, the tilting of the articles 112 causes accumulated liquid to be further distributed along the surfaces to facilitate drying of the articles.

In the embodiment shown the first portion 190 of the conveyor belt 180 extends from the infeed end 132 to the first roller 152. The first roller 152 is located proximate the receiving end 186 of the ramp 184 and redirects the conveyor belt 180 behind the ramp to form the first conveyor portion 190. Similarly, the second roller 154 is located to redirect the conveyor belt 180 such that the conveyor belt passes under the discharge end 188 of the ramp 184 to form the second conveyor portion 192.

In the embodiment shown, the roller 156 is located to cause the conveyor belt 180 to have a generally horizontal conveyor portion 194 following the ascending gradient of the second conveyor portion 192. The horizontal conveyor portion 194 facilitates unloading of articles discharged at the discharge end 134 of the drying chamber 126. Alternatively, the horizontal conveyor portion 194 may facilitate transfer of the articles 112 to another processing apparatus (not shown) having a receiving conveyor located to receive the discharged articles 112.

Referring back to FIG. 4, each of the rollers 152, 154 and 156 include a rotatable shaft 160 having ends supported by respective endplates 162 and 164. Each endplate 1162 and 164 includes a bushing 166 for receiving the respective ends of the shaft 160. In one embodiment the bushing 166 is fabricated from a heat resistant material, such as Rulon® J available from Saint-Gobain Performance Plastics. Rulon J is a gold polymer-filled material that provides a low abrasion mounting for the rotating shaft 160. Advantageously, the bushing 166 is able to withstand elevated temperatures in the drying chamber 126, which are likely to range from 240° F. to 275° F. Conventional lubricated bearings may fail under such elevated temperature conditions.

Each of the rollers 152, 154 and 156 include a plurality of sprockets 170 mounted in spaced apart relation on the shaft 160. Each sprocket 170 includes a plurality of sprocket teeth 172 for engaging the conveyor belt 180. In the embodiment shown, the rollers 152, 154 and 156 are idler rollers, which are able to rotate freely as the conveyor belt 180 is advanced, thereby supporting the belt. In one embodiment the sprockets 170 are produced from nylon material to withstand elevated temperatures and to reduce wearing of the conveyor belt 180 at points of engagement with the sprockets. As shown in FIG. 1, drive for advancing the conveyor may advantageously be provided by the driven roller 114, which is located outside the tunnel dryer 106, thereby avoiding the need to operate an electric motor in the drying chamber.

### Pulsating Air Jet

Referring back to FIG. 5, in the embodiment shown the tunnel dryer apparatus 106 also includes a plurality of spaced apart nozzles 198, operably configured to direct a pulsating jet of air toward passing articles 112. In general the number and orientation of nozzles 198 is selected to locate at least one of the spaced apart nozzles below each of the articles 112. The tunnel dryer apparatus 106 also includes a common air supply conduit 200 in communication with each of the plurality of spaced apart nozzles 198. The air supply conduit 200 is in communication with an air supply system for supplying pressurized air to the plurality of spaced apart nozzles.

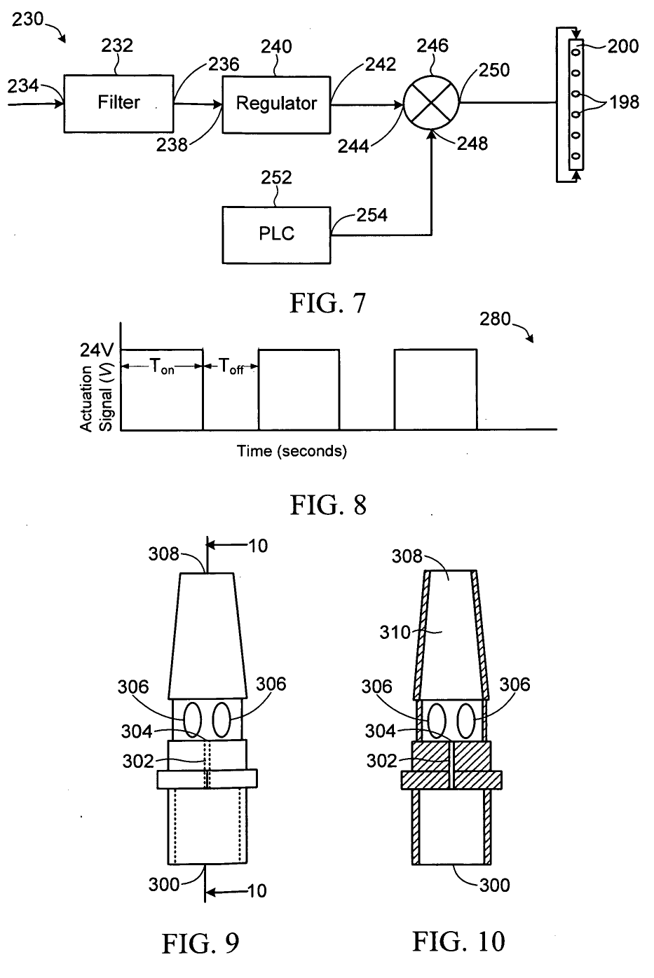

Referring to FIG. 7, the air supply system is shown generally at 230. The air supply system 230 includes a filter 232, which has an input port 234 in communication with a source of pressurized air (not shown). The pressurized air source will generally be provided by operating a common air compressor system. The filter 232 is operable to remove moisture and filter the air received at the input port 234 and produce a clean dry air supply at an output port 236 of the filter. In many laboratory environments, a supply of dry HEPA filtered air is provided, in which case the filter 232 may be omitted.

The output port 236 is in communication with an input port 238 of an adjustable regulator 240 for regulating pressure. The output port 236 of the filter may supply air at a pressure of about 90 psi or greater, and the regulator 240 may be adjusted to provide a desired supply pressure at an output port 242 of the regulator of about 60 psi.

The output port 242 of the regulator 240 is in communication with an input port 244 of a solenoid valve 246. The solenoid valve 246 includes a control input 248 for receiving an actuation signal for selectively activating the valve to open. The solenoid valve 246 further includes an output port 250 for producing a pulsating air supply, which is in communication with the common air supply conduit 200. The inventors have found that to provide a uniform air flow to each of the plurality of nozzles 198, the conduit 200 should be provided with a balanced air flow from either end of the conduit as shown in FIG. 7. Accordingly, as shown in FIG. 4, the conduit 200 is in communication with a first supply conduit 199 and a second supply conduit 201.

A suitable solenoid valve may be selected from the VG342 series of valves produced by SMC Corporation of Indianapolis, Ind. An example of a suitable valve is the SMC VG34-2R-5D-04NA, a three port pilot operated poppet solenoid valve, which is actuated by a 24 Volt DC actuation signal, has low electrical power consumption, and is rated for high frequency use.

In the embodiment shown in FIG. 7, the actuation signal is produced by a processor circuit such as a programmable logic controller (PLC) 252. The PLC 252 has an output 254 for producing the actuation signal for driving the solenoid valve. Referring to FIG. 8, an exemplary actuation signal is shown generally at 280. The actuation signal has a generally square waveform and having an active state of 24V DC and an in-active state of 0 V. The duty cycle of the waveform is defined by an on time Tₒₙ and an off time T_{off}. In one embodiment Tₒₙ is 1.2 seconds and T_{off} is 0.6 seconds giving a repetition period of 1.8 seconds. Advantageously the PLC may provide a plurality of user-selectable duty cycles and repetition periods for drying of various different articles. A suitable PLC's should have actuator outputs capable of producing a sufficiently high frequency actuation signal for driving the solenoid valve 246, such as the CQM1H PLC or CJ1M PLC manufactured by Omron Corporation of Kyoto, Japan.

The air supply system 230 produces the pulsating air supply by opening and closing the solenoid valve 246 in response to the actuation signal received from the PLC 252 at the input 248. When the actuation signal 280 is in the active state, the valve 246 opens and air permitted to flow between the input port 244 and the output port 250. When the actuation signal 280 is in the in-active state, the valve 246 closes and air prevented from reaching the output port 250.

One of the plurality of air nozzles 198 is shown in greater detail in FIG. 9 and in cross sectional view in FIG. 10. Referring to FIG. 9 and FIG. 10, the air nozzle 198 includes an air input port 300, which in use is in communication with the air supply conduit 200 for receiving the pulsating air supply. The nozzle 198 also includes a narrow conduit 302, which has an opening 304 for producing an upwardly directed airflow. The nozzle 198 also includes at least one orifice 306 (the nozzle shown in FIG. 9 includes a plurality of orifices 306). The orifices 306 are located proximate the opening 304. The nozzle 198 also includes a tapered chamber 310 having an opening 308.

The orifices 306 are in communication with an environment surrounding the nozzle 198 such that a pressure drop due to air flow through the narrow conduit 302 causes air from the surrounding environment to be drawn in through the orifices 306 through the Venturi effect. The heated air from the environment and the pressurized air venting through the opening 304 mix together in the tapered chamber 310 and are directed upwardly through the opening 308 to form the pulsating jet of air.

Referring back to FIG. 5, the respective pulsating jets of air are directed upwardly toward an underside of the articles 112. In the embodiment shown, the plurality of nozzles 198 are located to direct the pulsating jet of air upwardly through respective openings in the conveyor belt 180. Since the conveyor belt 180 may be wet, aligning the nozzles 198 with respective openings in the conveyor belt advantageously prevents liquid droplets from the conveyor being blown by the jets of air onto the articles. The inventors have also found that if the jet of air is generally oriented perpendicular to the articles 112, lighter articles may be held back by the force of the air jet impinging on vertically oriented sidewalls of the article. Accordingly, in one embodiment the nozzles 198 are oriented at an angle to produce a pulsating jet of air having an airflow component in the direction of motion of the articles 112 as shown in FIG. 6.

Advantageously, the respective pulsating jets of air directed toward the articles 112 cause accumulated liquid on surfaces of the articles to be dispersed to facilitate drying. The inventors have found that the pulsating action of the jets provides more effective dispersal of accumulated liquid than a continuous jet of air.

Furthermore, since the Venturi action of the nozzles 198 augments the air flow in the pulsating jets of air delivered to the articles, requirements for pressurized air supply to the tunnel dryer 106 are also reduced. In one embodiment the air flow delivered to each nozzle is about 13 cubic feet per minute (cfm).

Advantageously, by drawing in air from the surrounding environment (i.e. the drying chamber 126) the pulsating jets of air are formed in combination by heated air in the drying chamber and colder air supplied by the conduit 200, thereby eliminating the need to heat air supplied to the conduit 200. Although the pulsating air jets may increase an evaporation rate of the accumulated liquid from the articles 112, the primary function of the air jets is to disperse liquid over the surfaces of the articles to allow the heated air in the chamber and the latent heat of the articles themselves to dry the articles.

Referring back to FIG. 5, in another embodiment the tunnel dryer 106 may further include a second air supply conduit 202 in communication with a second plurality of nozzles 204 for directing a pulsating jet of air at upper surfaces of the articles 112. Alternatively, the conduits 200 and 202 and respective nozzles 198 and 204 may be located outside the drying chamber 126 in the unload section 108.

While specific embodiments of the invention have been described and illustrated, such embodiments should be considered illustrative of the invention only and not as limiting the invention as construed in accordance with the accompanying claims.

What is claimed is:

1. A tunnel dryer apparatus, the apparatus comprising:
a drying chamber having an infeed end for receiving articles to be dried; and
a conveyor for conveying the articles through the drying chamber along a drying path to a discharge end of the drying chamber, said drying path comprising at least one portion having a gradient for causing the articles to be tilted to distribute accumulated liquid on surfaces of the articles thereby facilitating drying of the article.

2. The apparatus of claim 1 wherein said at least one portion of said drying path having said gradient comprises a descending gradient portion of the drying path.

3. The apparatus of claim 2 said descending gradient portion of the drying path comprises a downwardly inclined ramp having a receiving end for receiving the articles, said downwardly inclined ramp being operable to cause the articles to slide under forces of gravity along the ramp toward a discharge end of said ramp.

4. The apparatus of claim 3 wherein said downwardly inclined ramp is operably configured to cause the articles to be decelerated proximate said discharge end of said ramp to dislodge residual accumulated liquid on said surfaces of the articles.

5. The apparatus of claim 3 wherein said conveyor comprises a first conveyor portion extending between said infeed end of the drying chamber and said receiving end of said ramp.

6. The apparatus of claim 5 wherein said conveyor comprises a second conveyor portion extending between said discharge end of said ramp and said discharge end of the drying chamber, said second conveyor portion being operable to receive the articles from said discharge end of said ramp.

7. The apparatus of claim 6 wherein said second conveyor portion has an ascending gradient for causing the articles to be tilted in an opposite direction with respect to the tilting direction provided by said ramp.

8. The apparatus of claim 7 further comprising a generally horizontal conveyor portion following said ascending gradient second conveyor portion.

9. The apparatus of claim 7 wherein said first conveyor portion and said second conveyor portion comprise a continuous conveyor belt extending between said infeed end and said discharge end of said drying chamber and wherein said ramp is disposed above said continuous conveyor and extends between said first and said second conveyor portions.

10. The apparatus of claim 9 further comprising a first roller located proximate said receiving end of said ramp for redirecting said continuous conveyor belt behind said ramp to form said first conveyor portion extending between said infeed end of the tunnel dryer and said first roller.

11. The apparatus of claim 10 wherein said first roller is supported at distally located ends of the first roller by a heat resistant bushing.

12. The apparatus of claim 11 wherein said heat resistant bushing comprises Rulon J material.

13. The apparatus of claim 9 further comprising a second roller located to redirect said continuous conveyor belt to pass under said discharge end of said ramp to form said second conveyor portion extending between said discharge end of said ramp and said discharge end of the drying chamber.

14. The apparatus of claim 13 wherein said infeed end of the drying chamber is in communication with a discharge end of a tunnel washer for receiving articles to be dried.

15. The apparatus of claim 14 wherein the articles to be dried comprise laboratory containers for holding live animals for scientific experimentation and wherein said discharge end of the drying chamber is in communication with a bedding dispenser for dispensing bedding material into said laboratory containers.

16. The apparatus of claim 1 further comprising a nozzle located along said drying path, said nozzle being operably configured to cause a pulsating jet of air to impinge on passing articles thereby causing accumulated liquid on surfaces of the articles to be dispersed to facilitate drying of the article.

17. The apparatus of claim 1 wherein said drying chamber comprises a plurality of channels for receiving heated air for drying the articles, at least one of said channels being oriented to direct heated air toward articles passing said at least one portion having said gradient.

18. A method for drying articles in a tunnel dryer, the method comprising:
receiving articles to be dried at an infeed end of a drying chamber of the tunnel dryer; and
conveying the articles through the drying chamber along a drying path to a discharge end of the drying chamber, said drying path comprising at least one portion having a gradient for causing the articles to be tilted to distribute accumulated liquid on surfaces of the articles thereby facilitating drying of the article.

19. The method of claim 18 wherein conveying the articles comprises causing the articles to be conveyed along a descending gradient portion of the drying path.

20. The method of claim 19 wherein causing the articles to be conveyed along said descending gradient portion of the drying path comprises causing the articles to be received at a receiving end of a downwardly inclined ramp and causing the articles to slide under forces of gravity along said ramp toward a discharge end of said ramp.

21. The method of claim 20 further comprising causing the articles to be decelerated proximate said discharge end of said ramp to dislodge residual accumulated liquid on said surfaces of the articles.

22. The method of claim 20 wherein receiving the articles at said receiving end of said ramp comprises receiving articles discharged from a first conveyor portion extending between said infeed end of the drying chamber and said receiving end of said ramp.

23. The method of claim 22 further comprising receiving the articles from said discharge end of said ramp at a second conveyor portion extending between said discharge end of said ramp and said discharge end of the drying chamber.

24. The method of claim 23 wherein receiving the articles from said discharge end of said ramp comprises receiving said articles at a second conveyor portion having an ascending gradient for causing the articles to be tilted in an opposite direction with respect to the tilting direction provided by said ramp.

25. The method of claim 24 wherein conveying the articles to a discharge end of the drying chamber comprises conveying articles along a generally horizontal conveyor portion following said ascending gradient second conveyor portion.

26. The method of claim 24 wherein said first conveyor portion and said second conveyor portion comprise a continuous conveyor belt extending between said infeed end and said discharge end of said drying chamber and wherein receiving the articles at said receiving end of said ramp comprises receiving said articles at a receiving end of a ramp disposed above said continuous conveyor, said ramp extending between said first and said second conveyor portions.

27. The method of claim 26 wherein receiving said articles discharged from said first conveyor portion comprises receiving articles from a first conveyor portion extending between said infeed end of the drying chamber and a first roller, said first roller being operable to redirect said conveyor belt behind said ramp.

28. The method of claim 27 wherein said first roller is supported at distally located ends of the first roller by a heat resistant bushing.

29. The method of claim 28 wherein said heat resistant bushing comprises Rulon J material.

30. The method of claim 27 wherein receiving the articles from said discharge end of said ramp at said second conveyor portion comprises receiving articles at a second portion of said continuous conveyor belt, said continuous conveyor belt being redirected around a second roller located to cause said continuous conveyor belt to pass under said discharge end of said ramp to form said second conveyor portion extending between said discharge end of said ramp and said discharge end of the drying chamber.

31. The method of claim 30 wherein receiving articles to be dried comprises receiving the articles from a discharge end of a tunnel washer.

32. The method of claim 31 wherein the articles to be dried comprise laboratory containers for holding live animals for scientific experimentation and wherein conveying the articles to said discharge end of the drying chamber comprises discharging the articles into a bedding dispenser for dispensing bedding material into the laboratory containers.

33. The method of claim 18 further comprising to causing a pulsating jet of air to impinge on passing articles thereby causing accumulated liquid on surfaces of the articles to be dispersed to facilitate drying of the article.

34. The method of claim 18 wherein said drying chamber comprises a plurality of channels for receiving heated air for drying the articles and further comprising causing at least a portion of said heated air to be directed toward articles passing said at least one portion having said gradient.

35. A tunnel dryer apparatus, the apparatus comprising:
means for receiving articles to be dried at an infeed end of a drying chamber of the tunnel dryer; and
means for conveying the articles through the drying chamber along a drying path to a discharge end of the drying chamber, said drying path comprising at least one portion having a gradient for causing the articles to be tilted to distribute accumulated liquid on surfaces of the articles thereby facilitating drying of the article.

36. The apparatus of claim 35 wherein said means for conveying the articles comprises means for causing the articles to be conveyed along a descending gradient portion of the drying path.

37. The apparatus of claim 35 further comprising means for causing a pulsating jet of air to impinge on passing articles thereby causing accumulated liquid on surfaces of the articles to be dispersed to facilitate drying of the article.

38. The apparatus of claim 35 wherein said drying chamber comprises a means for receiving heated air for drying the articles and further comprising means for causing at least a portion of said heated air to be directed toward articles passing said at least one portion having said gradient.

39. A tunnel dryer apparatus for drying articles received at an infeed end of a drying chamber, the apparatus comprising:
a conveyor for conveying the articles through the drying chamber along a drying path; and
a nozzle, operably configured to direct a pulsating jet of air toward passing articles thereby causing accumulated liquid on surfaces of the articles to be dispersed to facilitate drying of the article.

40. The apparatus of claim 39 wherein said nozzle comprises:
a narrow conduit in communication with a source of pressurized fluid, the narrow conduit having an opening for producing a jet of air; and
at least one orifice located proximate said opening, said orifice being in communication with an environment surrounding said nozzle such that a pressure drop due to air flow through the narrow conduit causes air from the surrounding environment to be drawn in through the at least one orifice to form said pulsating jet of air.

41. The apparatus of claim 39 further comprising a valve operably configured to be selectively actuated to couple a pressurized air source to said nozzle.

42. The apparatus of claim 41 wherein said valve comprises a solenoid valve operably configured to be selectively actuated in response to receiving an actuation signal.

43. The apparatus of claim 42 wherein said actuation signal comprises a periodic actuation signal that alternates between an inactive state and an active state, said active state being operable to actuate said solenoid valve to open, and wherein said actuation signal has a duty cycle of less than two seconds.

44. The apparatus of claim 43 wherein said periodic actuation signal comprises an active state of about 1.2 seconds and an in-active state of about 0.6 seconds.

45. The apparatus of claim 42 further comprising a controller operably configured to generate said actuation signal.

46. The apparatus of claim 45 wherein said controller comprises a processor circuit operably configured to generate said actuation signal.

47. The apparatus of claim 39 wherein said nozzle comprises a plurality of spaced apart nozzles, each being located to cause a pulsating jet of air to impinge on a respective one of said adjacent spaced apart articles.

48. The apparatus of claim 47 further comprising a common air supply conduit in communication with each of said plurality of spaced apart nozzles, said conduit being in communication with a source of pressurized air for supplying pressurized air to said plurality of spaced apart nozzles.

49. The apparatus of claim 39 wherein said drying path comprises a first portion extending between the infeed end and a discharge end of the drying chamber and a second portion extending past said discharge end of the drying chamber, and wherein said nozzle is located along said second portion of the drying path.

50. The apparatus of claim 39 wherein said conveyor comprises a conveyor belt extending along said drying path, said conveyor belt having a plurality of openings to permit passage of air through said conveyor belt, and wherein said nozzle is oriented to cause a pulsating jet of air to be directed through one of said plurality of openings.

51. The apparatus of claim 39 wherein said nozzle is oriented to produce an upwardly directed pulsating jet of air.

52. The apparatus of claim 51 wherein said nozzle is oriented to produce a jet of air having an airflow component in a direction of motion of said passing articles.

53. The apparatus of claim 39 wherein said nozzle is oriented to produce a downwardly directed pulsating jet of air.

54. A method for drying articles in a tunnel dryer, the method comprising:
receiving articles to be dried at an infeed end of a drying chamber of the tunnel dryer;
conveying the articles through the drying chamber along a drying path; and
causing a pulsating jet of air to impinge on passing articles thereby causing accumulated liquid on surfaces of the articles to be dispersed to facilitate drying of the article.

55. The method of claim 54 wherein causing said pulsating jet of air to impinge on passing articles comprises selectively supplying pressurized air to a nozzle to generate said pulsating jet of air.

56. The method of claim 55 wherein selectively supplying pressurized air to said nozzle comprises selectively supplying pressurized air to a nozzle having:
a narrow conduit in communication with a source of pressurized fluid, the narrow conduit having an opening for producing a jet of air; and
at least one orifice located proximate said opening, said orifice being in communication with an environment surrounding said nozzle such that a pressure drop due to air flow through the narrow conduit causes air from the surrounding environment to be drawn in through the at least one orifice to form said pulsating jet of air.

57. The method of claim 55 wherein selectively supplying pressurized air to said nozzle comprises causing a valve to be selectively actuated to couple a pressurized air source to said nozzle.

58. The method of claim 57 wherein causing said valve to be selectively actuated comprises causing a solenoid valve to be selectively actuated in response to receiving an actuation signal.

59. The method of claim 58 wherein receiving said actuation signal comprises receiving a periodic actuation signal that alternates between an inactive state and an active state, said active state being operable to actuate said solenoid valve to open, and wherein said actuation signal has a duty cycle of less than two seconds.

60. The method of claim 59 wherein receiving said periodic actuation signal comprises receiving a periodic actuation signal having an active state of about 1.2 seconds and an in-active state of about 0.6 seconds.

61. The method of claim 58 further comprising generating said actuation signal.

62. The method of claim 61 wherein generating said actuation signal comprises operably configuring a processor circuit to generate said actuation signal.

63. The method of claim 55 wherein conveying the articles comprises conveying a plurality of adjacent spaced apart articles along said drying path and wherein selectively supplying pressurized air to said nozzle comprises selectively supplying pressurized air to a plurality of spaced apart nozzles, each being located to cause a pulsating jet of air to impinge on a respective one of said adjacent spaced apart articles.

64. The method of claim 63 wherein selectively supplying pressurized air to said plurality of spaced apart nozzles comprises selectively supplying pressurized air to a common air supply conduit in communication with each of said plurality of spaced apart nozzles.

65. The method of claim 54 wherein conveying the articles along said drying path comprises conveying the articles along a drying path having a first portion extending between the infeed end and a discharge end of the drying chamber and a second portion extending past said discharge end of the drying chamber, and wherein causing said pulsating jet of air to impinge on passing articles comprises causing said pulsating jet of air to impinge on passing articles at a location along said second portion of the drying path.

66. The method of claim 54 wherein conveying the articles comprises conveying the articles along a conveyor belt extending along said drying path, said conveyor belt having a plurality of openings to permit passage of air through said conveyor belt, and wherein causing said pulsating jet of air to impinge on passing articles comprises causing a pulsating jet of air to be directed through one of said plurality of openings.

67. The method of claim 54 wherein causing said pulsating jet of air to impinge on passing articles comprises causing an upwardly oriented jet of air to impinge on passing articles.

68. The method of claim 67 wherein causing said upwardly oriented jet of air to impinge on passing articles comprises generating a jet of air having an airflow component in a direction of motion of said passing articles.

69. The method of claim 54 wherein causing said pulsating jet of air to impinge on passing articles comprises causing a downwardly oriented jet of air to impinge on passing articles.

70. A tunnel dryer apparatus for drying articles, the apparatus comprising:
means for receiving articles to be dried at an infeed end of a drying chamber of the tunnel dryer;
means for conveying the articles through the drying chamber along a drying path; and
means for causing a pulsating jet of air to impinge on passing articles thereby causing accumulated liquid on surfaces of the articles to be dispersed to facilitate drying of the article.

71. The apparatus of claim 70 wherein said means for causing said pulsating jet of air to impinge on passing articles comprises means for selectively supplying pressurized air to a nozzle to generate said pulsating jet of air.

72. The apparatus of claim 71 wherein said means for selectively supplying pressurized air to said nozzle comprises means for causing a valve to be selectively actuated to couple a pressurized air source to said nozzle.

73. The apparatus of claim 72 wherein said means for causing said valve to be selectively actuated comprises means for causing a solenoid valve to be selectively actuated in response to receiving an actuation signal.

74. The apparatus of claim 73 further comprising means for generating said actuation signal.
